(19) United States
(12) Patent Application Publication
(10) Pub. No.: US 2009/0126372 A1
(43) Pub. Date: May 21, 2009

(54) Intermittent De-Icing During Continuous Regasification of a Cryogenic Fluid Using Ambient Air

(76) Inventor: Solomon Aladja Faka, Woodland Hills, CA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/941,637

(22) Filed: Nov. 16, 2007

(51) Int. Cl. F17C 9/00

(52) U.S. Cl. 62/50.2; 60/641.1

(57) ABSTRACT

The present invention relates to a process and apparatus for regasifying a cryogenic liquid to gaseous form. Heat is transferred from ambient air to the cryogenic liquid across a heat transfer surface by circulating the cryogenic liquid or an intermediate fluid through an atmospheric vaporizer, wherein he ambient air and the cryogenic fluid or intermediate fluid are not in direct contact. A layer of ice forms on an external portion of the heat transfer surface exposed to the atmosphere where the temperature at the heat transfer surface is below the freezing temperature of water. The layer of ice is dislodged intermittently from the vaporizer using a source of heat operatively associated with a control device, the control device arranged to generate a signal when de-icing is required. De-icing is achieved without the need to discontinue circulating the cryogenic fluid or the intermediate fluid through the vaporizer.

### FIELD OF THE INVENTION

The present invention relates to a process and apparatus for regasification of a cryogenic liquid to gaseous form which relies on ambient air as the primary source of heat for vaporization and which is capable of being operated on a continuous basis. The present invention relates particularly, though not exclusively, to a process and apparatus for regasification of LNG to natural gas using ambient air as the primary source of heat for vaporization.

### BACKGROUND TO THE INVENTION

Natural gas is the cleanest burning fossil fuel as it produces less emissions and pollutants than either coal or oil. Natural gas (“NG”) is routinely transported from one location to another location in its liquid state as “Liquefied Natural Gas (“LNG”). Liquefaction of the natural gas makes it more economical to transport as LNG occupies only about 1/600th of the volume that the same amount of natural gas does in its gaseous state. Transportation of LNG from one location to another is most commonly achieved using double-hulled ocean-going vessels with cryogenic storage capability referred to as “LNGCs”. LNG is typically stored in cryogenic storage tanks onboard the LNGC, the storage tanks being operated either at or slightly above atmospheric pressure. The majority of existing LNGCs have an LNG cargo storage capacity in the size range of 120,000 m³ to 150,000 m³, with some LNGCs having a storage capacity of up to 264,000 m³.

LNG is normally regasified to natural gas before distribution to end users through a pipeline or other distribution network at a temperature and pressure that meets the delivery requirements of the end users. Regasification of the LNG is most commonly achieved by raising the temperature of the LNG above the LNG boiling point for a given pressure. It is common for an LNGC to receive its cargo of LNG at an “export terminal” located in one country and then sail across the ocean to deliver its cargo at an “import terminal” located in another country. Upon arrival at the import terminal, the LNGC traditionally berths at a pier or jetty and offloads the LNG as a liquid to an onshore storage and regasification facility located at the import terminal. The onshore regasification facility typically comprises a plurality of heaters or vaporizers, pumps and compressors. Such onshore storage and regasification facilities are typically large and the costs associated with building and operating such facilities are significant.

Recently, public concern over the costs and sovereign risk associated with construction of onshore regasification facilities has led to the building of offshore regasification terminals which are removed from populated areas and onshore activities. Various offshore terminals with different configurations and combinations have been proposed. For example, U.S. Pat. No. 6,089,022 describes a system and a method for regasifying LNG aboard a carrier vessel before the re-vaporized natural gas is transferred to shore for delivery to an onshore facility. The LNG is regasified using seawater taken from the body of water surrounding the carrier vessel which is flowed through a regasification facility that is fitted to and thus travels with the carrier vessel all of the way from the export terminal to the import terminal. The seawater exchanges heat with the LNG to vaporize the LNG to natural gas and the cooled seawater is returned to the body of water surrounding the carrier vessel. Seawater is an inexpensive source of intermediate fluid for LNG vaporization but has become less attractive due to environmental concerns; in particular, the environmental impact of returning cooled seawater to a marine environment.

Regasification of LNG is generally conducted using one of the following three types of vaporizers: an open rack type, an intermediate fluid type or a submerged combustion type.

Open rack type vaporizers typically use sea water as a heat source for the vaporization of LNG. These vaporizers use once-through seawater flow on the outside of a heater as the source of heat for the vaporization. They do not block up from freezing water, are easy to operate and maintain, but they are expensive to build. They are widely used in Japan. Their use in the USA and Europe is limited and economically difficult to justify for several reasons. First, the present permitting environment does not allow returning the seawater to the sea at a very cold temperature because of environmental concerns for marine life. Also, coastal waters like those of the southern USA are often not clean and contain a lot of suspended solids, which could require filtration. With these restraints the use of open rack type vaporizers in the USA is environmentally and economically not feasible.

Instead of vaporizing liquefied natural gas by direct heating with water or steam, vaporizers of the intermediate fluid type use propane, fluorinated hydrocarbons, or like refrigerant having a low freezing point. The refrigerant is heated with hot water or steam first to utilize the evaporation and condensation of the refrigerant for the vaporization of liquefied natural gas. Vaporizers of this type are less expensive to build than those of the open rack-type but require heating means, such as a burner, for the preparation of hot water or steam and are therefore costly to operate due to fuel consumption.

Vaporizers of the submerged combustion type comprise a tube immersed in water which is heated with a combustion gas injected thereinto from a burner. Like the intermediate fluid type, the vaporizers of the submerged combustion type involve a fuel cost and are expensive to operate. Evaporators of the submerged combustion type comprise a water bath in which the flue gas tube of a gas burner is installed as well as the exchanger tube bundle for the vaporization of the liquefied natural gas. The gas burner discharges the combustion flue gases into the water bath, which heat the water and provide the heat for the vaporization of the liquefied natural gas. The liquefied natural gas flows through the tube bundle. Evaporators of this type are reliable and of compact size, but they involve the use of fuel gas and thus are expensive to operate.

It is known to use ambient air or “atmospheric” vaporizers to vaporize a cryogenic liquid into gaseous form for certain downstream operations. An atmospheric vaporizer is a device which vaporizes cryogenic liquids by employing heat absorbed from the ambient air.

For example, U.S. Pat. No. 4,399,660, issued on Aug. 23, 1983 to Vogler, Jr. et al., describes an ambient air vaporizer suitable for vaporizing cryogenic liquids on a continuous basis. This device employs heat absorbed from the ambient air. At least three substantially vertical passes are piped together. Each pass includes a center tube with a plurality of fins substantially equally spaced around the tube.

U.S. Pat. No. 5,251,452, issued on Oct. 12, 1993 to L. Z. Wieder, discloses an ambient air vaporizer and heater for cryogenic liquids. This apparatus utilizes a plurality of vertically mounted and parallelly connected heat exchange tubes. Each tube has a plurality of external fins and a plurality of internal peripheral passageways symmetrically arranged in fluid communication with a central opening. A solid bar extends within the central opening for a predetermined length of each tube to increase the rate of heat transfer between the cryogenic fluid in its vapor phase and the ambient air. The fluid is raised from its boiling point at the bottom of the tubes to a temperature at the top suitable for manufacturing and other operations.

U.S. Pat. No. 6,622,492, issued Sep. 23, 2003, to Eyermann, discloses apparatus and process for vaporizing liquefied natural gas including the extraction of heat from ambient air to heat circulating water. The heat exchange process includes a heater for the vaporization of liquefied natural gas, a circulating water system, and a water tower extracting heat from the ambient air to heat the circulating water.

U.S. Pat. No. 6,644,041, issued Nov. 11, 2003 to Eyermann, discloses a process for vaporizing liquefied natural gas including passing water into a water tower so as to elevate a temperature of the water, pumping the elevated temperature water through a first heater, passing a circulating fluid through the first heater so as to transfer heat from the elevated temperature water into the circulating fluid, passing the liquefied natural gas into a second heater, pumping the heated circulating fluid from the first heater into the second heater so as to transfer heat from the circulating fluid to the liquefied natural gas, and discharging vaporized natural gas from the second heater.

The reason why atmospheric vaporizers are not generally used for continuous service is because ice and frost build up on the outside surfaces of the atmospheric vaporizer, rendering the unit inefficient after a sustained period of use. When an atmospheric vaporizer is used on an intermittent basis, the buildup of ice is generally not a problem, as the ice melts off when the unit is taken off-line. However, when the atmospheric vaporizer is required to operate on a continuous basis, the vaporizer is rendered inefficient after a sustained period of operation as the ice reduces the effective surface area of heat transfer for the vaporizer and acts as insulation, reducing the rate of heat transfer from the ambient air to the cryogenic fluid. As the efficiency of the atmospheric vaporizer decreases, either the exit flow rate or the exit temperature of the gas or both decrease. For this reason, atmospheric vaporizers are generally not preferred for continuous vaporization of stored cryogenic liquids.

The rate of accumulation of ice on the external fins depends, in part, on the differential in temperature between ambient temperature and the temperature of the cryogenic liquid inside of the tube. Typically, the largest portion of the ice packs tends to form on the tubes closest to the inlet, with little, if any, ice accumulating on the tubes near the outlet unless the ambient temperature is near or below freezing. It is therefore not uncommon for an ambient air vaporizer to have an uneven distribution of ice over the tubes which can shift the centre of gravity of the unit and which result in differential thermal gradients between the tubes.

Management of the problem of ice build up has been attempted in several ways. Periodic manual deicing is performed by personnel by applying external hot water jets or steam jets, and by mechanical removal using picks and shovels. The practice is undesirable in that manual action is required. The ice structure is unpredictable, and falling ice may injure personnel performing the work and may structurally damage the vaporizer and associated piping. Another technique is to accommodate ice build up on an initial length of bare piping, that is, piping without external fins, which is intended to serve as the primary surface upon which the ice will deposit. This technique is used because bare piping is less costly than the finned piping and can be supported in a less costly array to accommodate high ice build-up. However, an undesirably large amount of bare piping, floor space, and structural support needs to be used, making this technique unattractive.

Another prior art technique has been to provide one or more duplicate or redundant banks of vaporizers. While one bank of vaporizers is in active service, one or more other banks is taken offline to allow the ice to melt. A number of schemes may be used for switching banks. A simple scheme is to switch banks purely on a time schedule thereby disregarding other considerations. The use of redundant vaporizers adds to the cost of the regasification facility, whilst also increasing the amount of space required. Yet another prior art solution has been to oversize the regasification facility resulting in reduced average heat transfer loading per vaporizer, thereby increasing the cost and floor space requirement.

For the foregoing reasons, there remains a need for a process and apparatus for regasification of a cryogenic fluid which can operate continuously without requiring redundant vaporizers and which can overcome or at least ameliorate the heretofore decrease in operating efficiency characteristic of atmospheric vaporizers of the prior art.

### SUMMARY OF THE INVENTION

According to a first aspect of the present invention there is provided a process for regasifying a cryogenic liquid to gaseous form, the process comprising:

(a) transferring heat from ambient air to the cryogenic liquid across a heat transfer surface by circulating the cryogenic liquid or an intermediate fluid through an atmospheric vaporizer, wherein the ambient air and the cryogenic fluid or intermediate fluid are not in direct contact;

(b) allowing a layer of ice to form, in use, on at least that external portion of the heat transfer surface exposed to the atmosphere where the temperature at the heat transfer surface is below the freezing temperature of water; and,

(c) intermittently dislodging the layer of ice from the vaporizer using a source of heat operatively associated with a control device, the control device arranged to generate a signal when de-icing is required, the source of heat being directed at the interface between the layer of ice and the heat transfer surface of the vaporizer, and whereby de-icing is achieved without the need to discontinue circulating the cryogenic fluid or the intermediate fluid through the vaporizer.

In one form, the control device generates a signal to initiate step (c) when the temperature of the gaseous form of the cryogenic liquid which exits the vaporizer drops below a predetermined minimum temperature. In another form, the control device generates a signal to initiate step (c) when the flow rate of the gaseous form of the cryogenic liquid which exits the vaporizer has dropped below a predetermined minimum flow rate.

Suitable sources of heat for step (c) may be one or more of electrical energy; waste heat recovered from a propulsion system of an RLNGC; steam from a waste heat boiler or other source; heat generated using a submerged combustion vaporizer; solar energy; electric heaters using the excess electric generating capacity of the propulsion plant when the RLNGC is moored; exhaust gas heat exchangers fitted to the combustion exhausts of a diesel engine or a gas turbine; or natural gas-fired hot water or thermal oil heaters; or heat generated by direct firing using natural gas or oil, or microwave energy.

In one form, the source of heat for step (c) is one or more electrical heating elements arranged at the interface between the heat transfer surface of the vaporizer and the layer of ice. When the vaporizer includes at least one tube, the electrical heating elements may be arranged on the exterior heat transfer surface of the tube. When the vaporizer includes at least one tube, and each tube includes a plurality of radial fins, the electrical heating elements may be arranged on one or all of the radial fins. Advantageously, the electrical heating elements may be self-regulating.

In another form, when the vaporizer includes at least one tube, the source of heat for step (c) may be a heated fluid which is circulated, in response to the signal generated by the control device, through a de-icing duct arranged along at least that portion of the tube where icing is expected to occur. When the tube includes a plurality of fins, the de-icing duct may be positioned on the exterior heat transfer surfaces of the tube adjacent to the base of adjacent radial fins. Alternatively or additionally, each de-icing duct may be arranged along the length of a radial fin so as to provide each fin with a hollow core through which the heated fluid is caused to flow.

Preferably, the heated fluid is dry superheated steam and the dry superheated steam may be generated using a waste heat boiler arranged to exchange heat with hot exhaust gas generated by an engine.

When an intermediate fluid is used to transfer heat indirectly from the ambient air to the cryogenic fluid, the intermediate fluid may be selected from the group consisting of a glycol, a glycol-water mixture, methanol, propanol, propane, butane, ammonia, a formate, fresh water and tempered water. In one form, the intermediate fluid comprises a solution containing an alkali metal formate or an alkali metal acetate.

In one form of the process, step a) is encouraged through use of forced draft fans.

When the atmospheric vaporizer comprises a plurality of passes, the passes may be spaced apart from one another and arranged in an array. Preferably, each pass has a vertical orientation and adjacent passes are connected in series or parallel or in a combination of series and parallel configurations. In one form, each pass comprises at least one tube having a central bore through which the cryogenic liquid is caused to flow, each tube having a finned exterior surface, an inlet for fluid flow at one end, and an outlet for fluid flow at the other distal end of the tube.

In one form, the vaporizer is provided in a regasification system for installation aboard a floating carrier vessel and the source of heat for step (c) is recovered from the engines of the LNG carrier. Preferably, the cryogenic fluid is LNG.

According to a second aspect of the present invention there is provided an apparatus for regasifying a cryogenic liquid to gaseous form, the apparatus comprising:

an atmospheric vaporizer for transferring heat from ambient air to the cryogenic liquid across a heat transfer surface by circulating the cryogenic liquid or an intermediate fluid through the atmospheric vaporizer, wherein the ambient air and the cryogenic fluid or intermediate fluid are not in direct contact;

a control device for intermittently dislodging a layer of ice from the vaporizer using a source of heat operatively associated with a control device, the layer of ice being allowed to form, in use, on at least that external portion of the heat transfer surface exposed to the atmosphere where the temperature at the heat transfer surface is below the freezing temperature of water, the control device being arranged to generate a signal when de-icing is required; and

a source of heat directed at the interface between the layer of ice and the heat transfer surface of the vaporizer, whereby de-icing is achieved without the need to discontinue circulating the cryogenic fluid or the intermediate fluid through the vaporizer.

In one form, the control device includes a temperature sensor for measuring the temperature of the gaseous form of the cryogenic liquid which exits the vaporizer, and a signal generator for generating a signal to initiate intermittent de-icing when the temperature measured by the temperature sensor drops below a predetermined minimum temperature. In another form, the control device includes a flow meter for measuring the flow rate of the gaseous form of the cryogenic liquid which exits the vaporizer, and a signal generator for generating a signal to initiate intermittent de-icing when the flow rate measured by the flow meter drops below a predetermined minimum flow rate.

The source of heat may be one or more of: electrical energy; waste heat recovered from a propulsion system of an RLNGC; steam from a waste heat boiler or other source; heat generated using a submerged combustion vaporizer; solar energy; electric heaters using the excess electric generating capacity of the propulsion plant when the RLNGC is moored; exhaust gas heat exchangers fitted to the combustion exhausts of a diesel engine or gas turbine; or natural gas-fired hot water or thermal oil heaters; or heat generated by direct firing using natural gas or oil.

In one form, the source of heat is one or more electrical heating elements arranged at the interface between the heat transfer surface of the vaporizer and the layer of ice. When the vaporizer includes at least one tube, the electrical heating elements may be arranged on the exterior heat transfer surface of the tube. When the vaporizer includes at least one tube, each tube including a plurality of radial fins, the electrical heating elements may be arranged on one or all of the radial fins. In one form, the electrical heating elements are self-regulating.

In another form, the vaporizer includes at least one tube, and the source of heat is a heated fluid which is circulated, in response to the signal generated by the control device, through a de-icing duct arranged along at least that portion of the tube where icing is expected to occur. When the tube includes a plurality of fins, the de-icing duct may be positioned on the exterior heat transfer surfaces of the tube adjacent to the base of adjacent radial fins. Preferably, the heated fluid is dry superheated steam. The dry superheated steam may be generated using a waste heat boiler arranged to exchange heat with hot exhaust gas generated by an engine.

In one form, the apparatus further comprises forced draft fans for directing the flow of ambient air towards the vaporizer.

In one form, the vaporizer is provided in a regasification system for installation aboard a floating carrier vessel and the source of heat is recovered from the engines of the LNG carrier.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a side view of the RLNGC provided with an onboard regasification facility for continuous regasification of LNG stored onboard the RLNGC to natural gas which is transferred via a marine riser associated with a sub-sea pipeline to shore;

FIG. 2 is a flow chart illustrating one embodiment of the regasification facility including an atmospheric vaporizer through which LNG is circulated for direct heat transfer with ambient air;

FIG. 3 is a cross-sectional view of two adjacent tubes showing the layer of ice which builds up between adjacent fins or adjacent tubes;

FIG. 4a is an isometric view of one embodiment of a four pass vaporizer including collection tray;

FIG. 4b is an isometric view of a single pass vaporizer including an inlet manifold and an outlet manifold;

FIG. 5a is a cross-sectional view through four tubes of an atmospheric vaporizer illustrating the flow of fluid through the tubes of a multi-pass;

FIG. 5b is a cross-section view through four tubes of a single pass atmospheric vaporizer illustrating the flow of fluid through the tubes;

FIG. 6a is a partial isometric view of one tube showing the radial fins and using electrical heating elements to provide a source of heat to the external surfaces of the tube for periodically dislodging a layer of ice from the heat transfer surfaces of the vaporizer;

FIG. 6b is a partial isometric view of one tube showing de-icing ducts positioned at the base of adjacent radial fins through which a heated fluid is caused to flow intermittently to dislodge ice from the tubes;

FIG. 6c is a partial isometric view of one tube with de-icing ducts arranged along the length of a radial fin so as to provide each fin with a hollow core through which the heated fluid is caused to flow; and

FIG. 7 illustrates another embodiment of the regasification facility including an atmospheric vaporizer through which an intermediate fluid is circulated for heat transfer with ambient air, the heated intermediate fluid then being used to transfer heat to vaporizer LNG to form natural gas.

Like reference numerals have been used to identify like elements throughout this disclosure.

### DETAILED DESCRIPTION OF PREFERRED EMBODIMENTS

Particular embodiments of the method and apparatus for regasification of a cryogenic fluid to gaseous form using ambient air as the primary source of heat for vaporization are now described, with particular reference to the offshore regasification of liquefied natural gas (“LNG”) aboard an LNG Carrier, by way of example only. The present invention is equally applicable to use for regasification of other cryogenic liquids and also equally applicable to an onshore regasification facility or for use on a fixed offshore platform or barge. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs.

Throughout this specification the term “RLNGC” refers to a self-propelled vessel, ship, or LNG carrier provided with an onboard regasification facility which is used to convert LNG to natural gas. The RLNGC can be a modified ocean-going LNG vessel or a vessel that is custom or purpose built to include the onboard regasification facility.

The term “vaporizer” as used herein refers to a device which is used to convert a liquid into a gas. An “atmospheric vaporizer” as used herein refers to a device which is used to convert a liquid into a gas using atmospheric air as the primary source of heat.

The term “cryogenic liquid” as used herein refers to a liquid which has an atmospheric boiling point below 200 Kelvin (−73° C.).

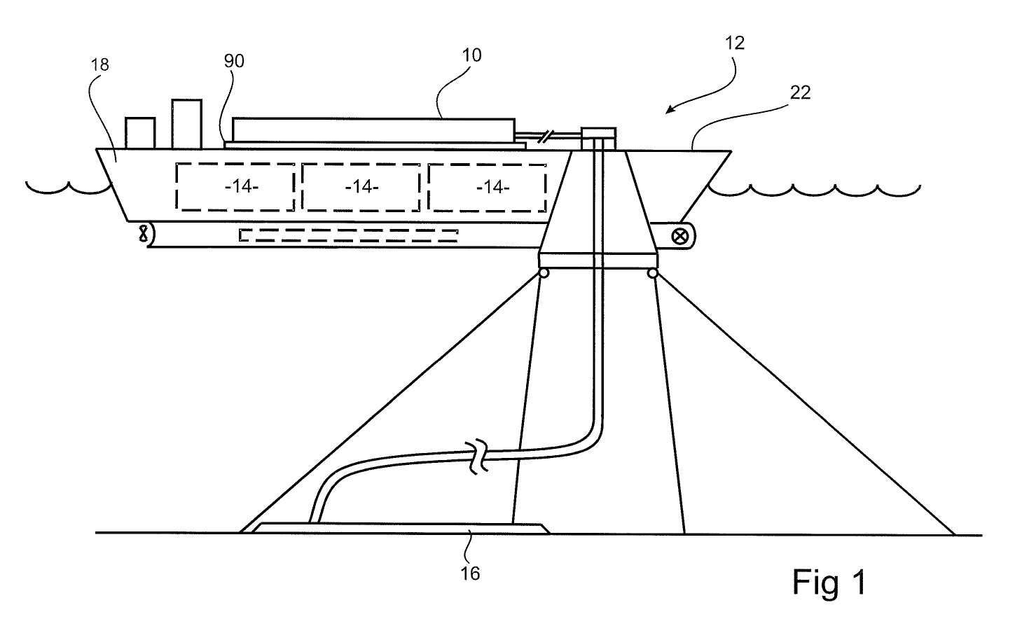

A first embodiment of the process and system of the present invention is now described with reference to FIGS. 1 to 6. In this first embodiment, a regasification facility 10 is provided onboard an RLNGC 12 and is used to regasify LNG that is stored aboard the RLNGC 12 in one or more cryogenic storage tanks 14. The onboard regasification facility 10 uses ambient air as the primary source of heat for regasification of the LNG to form natural gas. Ambient air is used (instead of heat from burning of fuel gas) as the primary source of heat for regasification of the LNG to keep emissions of nitrous oxide, sulphur dioxide, carbon dioxide, volatile organic compounds and particulate matter to a minimum. The natural gas produced using the onboard regasification facility 10 is transferred to a sub-sea pipeline 16 for delivery of the natural gas to an onshore gas distribution facility (not shown).

In one embodiment of the present invention, LNG is stored aboard the RLNGC in 4 to 7 prismatic self-supporting cryogenic storage tanks 14, each storage tank 14 having a gross storage capacity in the range of 30,000 m³ to 50,000 m³. The RLNGC has a supporting hull structure 18 capable of withstanding the loads imposed from intermediate filling levels in the storage tanks 14 when the RLNGC is subject to harsh, multi-directional environmental conditions. The storage tank(s) 14 onboard the RLNGC are robust to reduce sloshing of the LNG when the storage tanks are partly filled, or when the RLNGC is riding out a storm whilst moored. To reduce the effects of sloshing, the storage tank(s) 14 are provided with a plurality of internal baffles or a reinforced membrane. The use of membrane storage tanks or prismatic storage tanks allows more space on the deck of the RLNGC for the regasification facility. Self supporting spherical cryogenic storage tanks (e.g., MOSS type tanks) are not considered to be suitable if the RLNGC is fitted with an onboard regasification facility, as MOSS tanks reduce the deck area available to position the regasification facility on the deck 22 of the RLNGC 12.

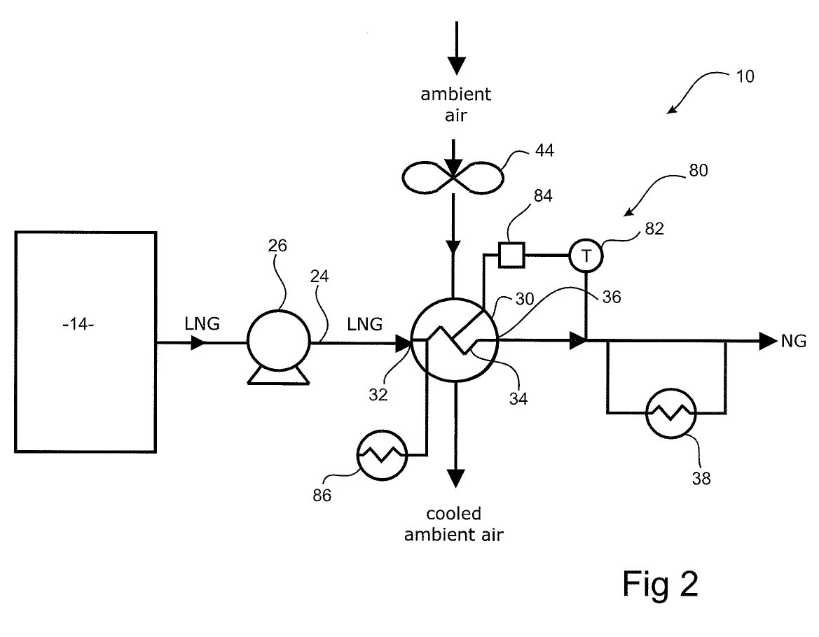

Referring to FIG. 2, LNG from the storage tank 14 is conveyed to the regasification facility 10 at the required send-out pressure through a high pressure onboard piping system 24 using at least one cryogenic send-out pump 26. Examples of suitable cryogenic send-out pumps include a centrifugal pump, a positive-displacement pumps, a screw pump, a velocity-head pump, a rotary pump, a gear pump, a plunger pump, a piston pump, a vane pump, a radial-plunger pump, a swash-plate pump, a smooth flow pump, a pulsating flow pump, or other pumps that meet the discharge head and flow rate requirements of the vaporizers. The capacity of the send-out pump 26 is selected based upon the type and quantity of vaporizers 30 installed in the regasification facility 10, the surface area and efficiency of the vaporizers 30 and the degree of redundancy desired. They are also sized such that the RLNGC can discharge its cargo at a conventional import terminal at a rate of 10,000 m³/hr (nominal) with a peak in the range of 12,000 m³/hr to 16,000 m³/hr.

In the illustrated embodiment of FIG. 2, the LNG is directed to flow into the tube-side inlet 32 of an atmospheric vaporizer 30. The LNG is vaporized as it passes through the tubes 34 of the vaporizer 30 to form natural gas which exits the vaporizer 30 through the tube-side outlet 36. If the natural gas that exits the tube-side outlet 36 of the vaporizer 30 is not already at a temperature suitable for distribution into the sub-sea pipeline 16, its temperature and pressure can be boosted by directing some or all of the natural gas through a supplemental heater 38. Suitable sources of heat for the supplemental heater 38 include one or more of: heat from engine cooling; waste heat recovery from power generation facilities and/or electrical heating from excess power from the power generation facilities; an exhaust gas heater; an electric water or fluid heater; a propulsion unit of the ship (when the regasification facility is onboard an RLNGC); a diesel engine; or a gas turbine propulsion plant.

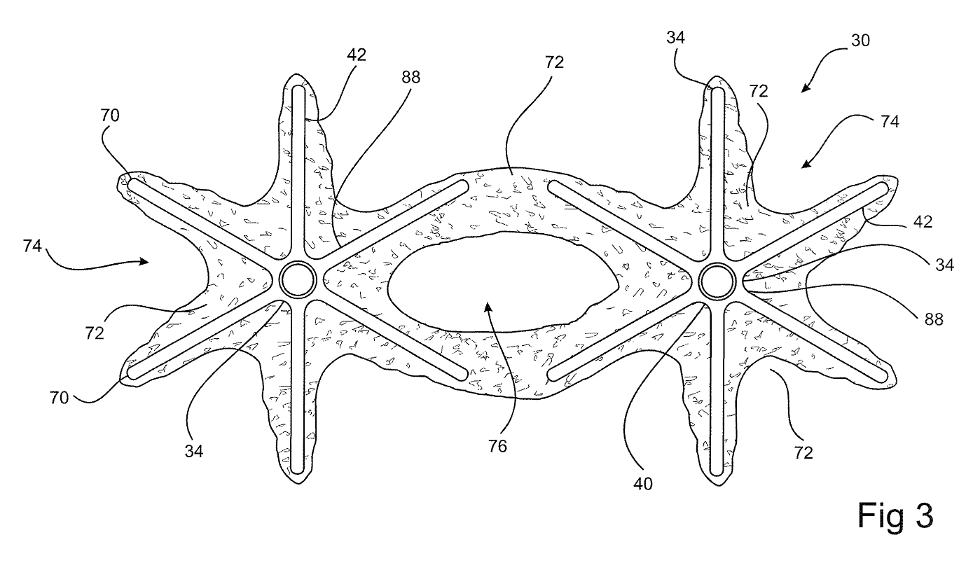

With reference to FIG. 3, the LNG is regasified to form natural gas as it flows through the internal hollow bore 40 of the tubes 34 of the vaporizer 30 by heat exchange with ambient air acting on the exterior heat transfer surfaces 42 of the tubes 34 of the vaporizer 30. The LNG is warmed by the ambient air as a function of the temperature differential between the ambient air and the temperature and flow rate of the LNG through the tubes 34 of the vaporizer 30. Each tube 34 is constructed from a material having good heat transfer characteristics, with aluminum, stainless steel or MONEL being preferred materials. Heat transfer between the ambient air and the LNG can be assisted through the use of forced draft fans 44 (FIG. 2) arranged to direct the flow of air towards the atmospheric vaporizer 30, preferably in a downward direction.

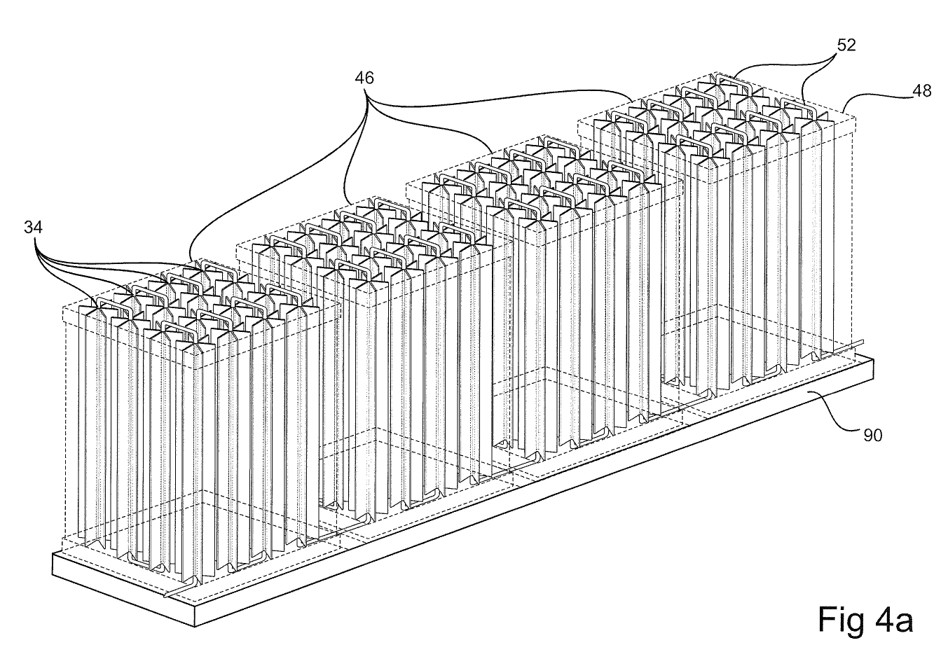

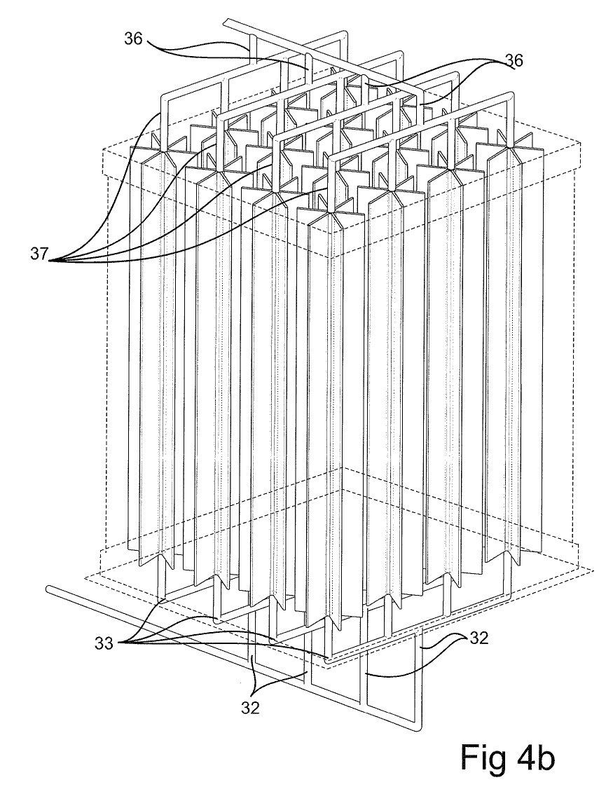

FIG. 4 illustrates an atmospheric vaporizer 30 including a plurality of passes 46, the passes being spaced apart from one another and arranged in a square, rectangular or triangular array. The passes 46 may be connected in series or parallel or in a combination of series and parallel configurations. The number of passes 46 the fluid flows through and the path of the fluid flow through the vaporizer 30 (i.e., series, parallel, or a combination of series and parallel) will depend on various factors, such as end use temperature and flow rate requirements, ambient temperature, heat transfer characteristics, pressure drop factors and other considerations which are known to those skilled in the art. It is thus equally permissible for the atmospheric vaporizer 30 to have only a single pass 46. For best results, the tubes 34 are vertically oriented, being held in place by suitable supports 48 with clearance being provided between the vaporizer 30 and the surface upon which the vaporizer 30 rests.

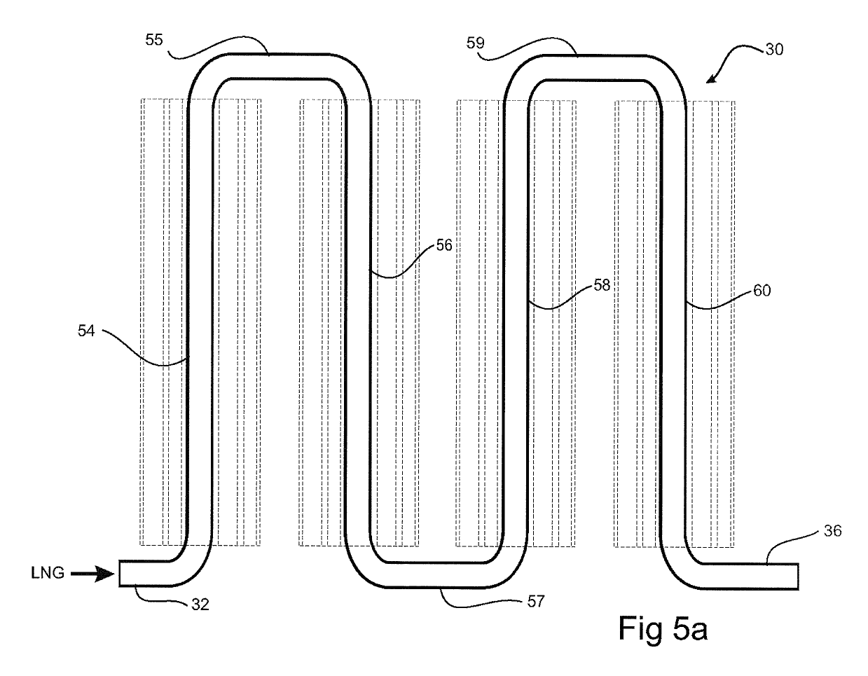

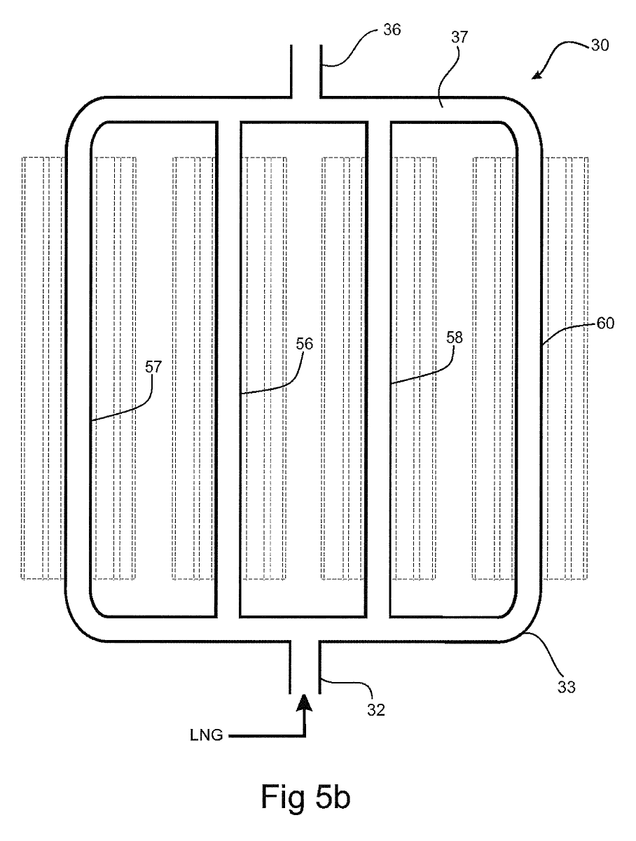

Each pass 46 comprises a plurality of tubes 34 connected together in any suitable manner. In the embodiment illustrated in FIG. 4a and FIG. 5a, four tubes 34 of a multi-pass vaporizer 30 are shown to illustrate how the cryogenic fluid is caused to flow through the vaporizer 30. Specifically, the pass 46 includes a first tube 54, a second tube 56, a third tube 58, and a fourth tube connected via connector tubes 52. In operation, the LNG enters the tube-side inlet 32 of the vaporizer 30 at the bottom of a first tube 54, travels up the first tube 54 and over through a first connector 55 to an adjacent second tube 56, down the second tube 56 and across through a second connector 57 to the adjacent third tube 58, up the third tube 58 and over through a third connector 59 to the adjacent fourth tube 60, and down the fourth tube 60 in series and out of the tube-side outlet 36 where it exits the vaporizer 30 as natural gas at a temperature appropriate for a nominated end use. An alternative is illustrated in FIGS. 4b and 5b for which like reference numerals refer to like parts. In this embodiment, the LNG enters the tube-side inlet 32 of the vaporizer 30 and is directed to flow through each of the first, second, third, and fourth tubes 54, 56, 58 and 60, respectively, in a single pass to form natural gas which leaves the vaporizer via the tube-side outlet 36. The tube-side inlet 32 includes an inlet manifold 33 for distributing the cryogenic fluid into each of the first, second, third and fourth tubes 54, 56, 58, and 60, respectively. The tube-side outlet 36 includes an outlet manifold 37 for receiving the gas from in each of the first, second, third and fourth tubes 54, 56, 58, and 60, respectively, and directing the gas to flow out of the vaporizer 30 through the tube-side outlet 36.

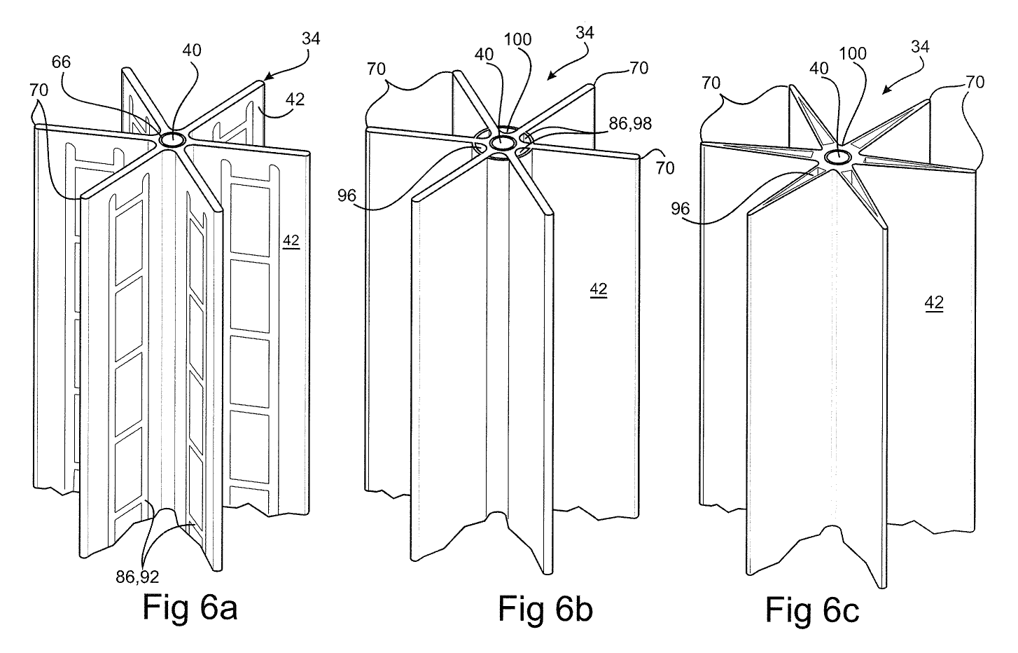

With reference to FIGS. 6a, 6b, and 6c, each tube 34 has a central bore 40 through which LNG is caused to flow. Each tube 34 has a finned exterior heat transfer surface 42, and, optionally a finned interior surface, an inlet 66 for fluid flow at one end, an outlet for fluid flow at the other distal end, and a sufficient wall thickness to contain the LNG at the requisite send-out pressure. Each tube 34 is provided with a plurality of radial fins 70 extending along the length of the tube, the radial fins 70 being spaced substantially equidistant from each other around the circumference of the tube 34. By way of example, when the tube 34 is provided with six radial fins, each fin 70 is arranged around the circumference of the tube 34 at an angle of approximately 30 degrees to each other. The radial fins are used to increase the effective surface area for heat exchange being the cryogenic fluid and the ambient air, as well as to provide additional mechanical support to the tubes.

As the LNG passes through the tubes 34 of the atmospheric vaporizer 30, the exterior heat transfer surface 42 of the tubes 34 is cooled to a temperature ranging from the boiling temperature of the LNG to temperatures approaching the prevailing ambient air temperature. As the ambient air transfers heat to the LNG to vaporize it to natural gas, the ambient air itself is cooled. Moisture in the air condenses to form a layer of ice 72 (shown in FIG. 3) on the exterior heat transfer surfaces 42 of the vaporizer 30. The latent heat of condensation provides an additional source of heat to be transferred to the circulating LNG in addition to the sensible heat from the air. The layer of ice 72 builds up over time on the portion of the exterior surface 42 of the vaporizer 30 where the temperature falls below the freezing point of water. The layer of ice 72 may completely fill the space 74 between adjacent fins 70 on the external surface 42 of the tubes 34, and, in time, may even fill the space 76 between adjacent tubes 34 or between adjacent passes 46. The rate and degree of icing which occurs depends on a number of relevant factors including, but not limited to, the temperature and relative humidity of the ambient air, the flow rate of the LNG through the ambient air vaporizer 30, and the heat transfer characteristics of the materials of construction of the ambient air vaporizer 30. The temperature and relative humidity of the ambient air can vary according to the seasons or the type of climate in the location at which regasification is conducted.

Using the process of the present invention, the rate of build-up of the layer of ice 72 on the external surfaces 42 of the ambient air vaporizer 30 is monitored. As the layer of ice increases in thickness, the efficiency of heat transfer between the ambient air and the LNG is reduce, resulting in a lower temperature or a reduction in the flow rate of the natural gas which flows out of the tube-side outlet 36 of the vaporizer 30 if the temperature is kept constant. In one embodiment of the process and apparatus of the present invention, a control device 80, in the form of a temperature sensor 82 cooperatively associated with a signal generator 84, is used to generate a signal to indicate that the temperature of the natural gas which exits the tube-side outlet 36 of the vaporizer 30 has dropped below a predetermined minimum temperature. The temperature sensor 82 is disposed at the tube-side outlet 36 of the vaporizer 30 and generates a switching signal indicating when the temperature of the fluid leaving the tube-side outlet 36 of the vaporizer 30 has fallen below a predetermined set point temperature. When a switching signal is generated by the signal generator 84, flow of the LNG through the vaporizer 30 is allowed to continue whilst a source of heat 86 is applied at the interface 88 between the layer of ice 72 and the heat transfer surfaces 42 of the vaporizer 30 so as to dislodge the layer of ice 72 from the heat transfer surfaces 42 of the vaporizer 30. The dislodged layer of ice 72 is allowed to fall under gravity into a collection trap 90 in which the ice is allowed to melt to produce fresh water. In this way, the ambient air vaporizer undergoes routine intermittent de-icing to improve efficiency without interrupting the flow of LNG through the vaporizer, allowing the regasification facility to operate on a continuous basis.

It is to be understood that the process of the present invention is not one in which the ice is removed from the external surfaces of the vaporizer through complete melting of the ice by external application of heat. On the contrary, the source of heat 86 is applied to the interface of the ice and the heat transfer surface of the tubes to encourage the layer of ice to become separated from the exterior heat transfer surfaces 42 of the vaporizer 30. The layer of ice is removed intermittently in this way, so that ambient air can come into contact with the exterior heat transfer surfaces 42 of the vaporizer to optimize the exchange of heat between the ambient air and the LNG being circulated through the tubes of the vaporizer. In this regard, the source of heat is essentially applied to the layer of ice from the tube-side out rather in stark contrast to prior art methods which rely on heat being applied to the outer exterior surface of the layer of ice. Applying a source of heat at the interface between heat transfer surface 42 and the layer of ice 72 using the process of the present invention allows for vaporization to continue during de-icing operations as the heat used to dislodge the ice performs the secondary function of providing heat for vaporization of the cryogenic fluid flowing through the vaporizer 30.

Suitable source of heat 86 for intermittent de-icing the vaporizers include electrical cabling referred to in the refrigeration art as “electrical heat tracing”, waste heat recovered from a propulsion system of an RLNGC, steam from a waste heat boiler or other source, heat generated using a submerged combustion vaporizer, solar energy, electric heaters using the excess electric generating capacity of the propulsion plant when the RLNGC is moored, exhaust gas heat exchangers fitted to the combustion exhausts of a diesel engine or gas turbine, or natural gas-fired hot water or thermal oil heaters or microwave energy. The secondary source of heat can equally be generated by direct firing using natural gas or oil when additional heat is needed.

In the embodiment illustrated in FIG. 6a, the layer of ice 72 is dislodged using partial melting at the interface between the layer of ice 72 and the exterior heat transfer surface 42 of a tube 34, using a source of heat 86 in the form of electrical heating using an electrical resistance heating element or cable 92. The electrical heating elements 92 are arranged on the exterior heat transfer surface 42 of the tube 34 which represents the interface between the exterior heat transfer surfaces 42 of the vaporizer 30 and the layer of ice 72 which forms in use. The electrical elements 92 are used to generate sufficient heat to dislodge the layer of ice 72 from the vaporizer 30 in response to a switching signal being generated by the signal generator 84 in the manner described above. Electrical power to the heating elements 92 is regulated in accordance with the switching signal from the temperature sensor 82 which is used to cycle the electrical power to the heating elements 92 between a dormant cycle and a de-icing cycle.

The heating elements 92 may be internal or external to the tubes 34, or may be arranged on the fins 70 as shown in FIG. 6a. The heating elements 92 are operatively connected to an electric control means 84, including a switch for regulating power supply to the heating cable at desired intervals, and a rheostat for controlling the temperature of the heating cable. The electrical power to the heating element 92 is regulated in accordance with the switching signal from the temperature sensor 82, which is used to cycle the electrical power to the heating cable between a dormant cycle and a de-icing cycle. Alternatively, if desired, self-regulating heating elements can be used to automatically adjust power output to compensate for temperature changes.

In the embodiments illustrated in FIG. 6b and FIG. 6c, the layer of ice 72 is dislodged using a source of heat in the form of a heated fluid which is circulated intermittently through the hollow bore 96 of a thin-walled de-icing duct 98 arranged along at least that portion of each tube 34 where icing is expected to occur. If desired, the de-icing duct 98 can extend along the full length of the tube 34, extending from the inlet end of the tube to the discharge end of the tube. The de-icing duct 98 is constructed of a high conductivity metal such as steel, having a central bore 96 through which the hot fluid is operatively circulated. In the embodiment illustrated in FIG. 6b, the de-icing ducts 98 are positioned on the exterior heat transfer surface 42 of the tubes 34 adjacent to the base 100 of each radial fin 70. In this way, the de-icing ducts 86 are positioned as close as possible to the hollow bore 40 of the tube 34 through which the LNG is caused to flow. In the embodiment illustrated in FIG. 6c, the de-icing ducts 98 are arranged along the length of each radial fin 70 so as to provide each fin with a hollow core through which the heated fluid is caused to flow. In this way, the fins 70 are essentially heated from the inside out, with the layer of ice 70 becoming dislodged as the temperature at the exterior heat transfer surface 42 of the tube 34 is raised above zero degrees Celsius.

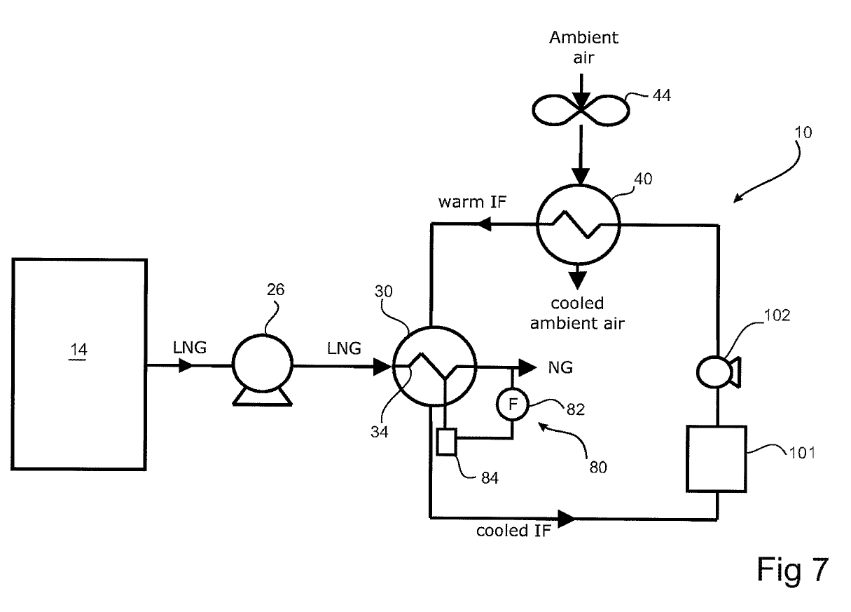

In operation, when a signal is generated from the control device 80 to indicate that de-icing is required, a pulse of heated fluid is caused to flow through the de-icing duct 98 of the tube 34 to dislodge the layer of ice 72 from the exterior heat transfer surface 42 of the tube 34, due to a combination of the heat generated by the heated fluid and the radial forces generated as the duct 98 expands due to the heat generated by the heated fluid. In this way, the source of heat 86 is directed at the interface 88 between the layer of ice 72 and the exterior heat transfer surface 42 of the vaporizer 30. In the embodiment illustrated in FIG. 7, the control device 80 initiates de-icing when the flow rate of the natural gas which exits the tube-side outlet 36 of the vaporizer 30 has dropped below a predetermined minimum flow rate.

In the embodiment illustrated in FIG. 6b and 6c, the heated fluid is dry superheated steam which is generated using a waste heat boiler arranged to exchange heat with hot exhaust gas generated by an engine. The steam can equally be generated using a dedicated electrical steam generator. Preferably, the dry superheated steam at a temperature in the order of 500 to 650° C., so that the temperature of the superheated steam is sufficiently high so that the amount of heat being generated when the steam is pulsed through the duct is sufficient to provide the heat required to dislodge the layer of ice 72 from the external heat transfer surfaces 42 of the tubes 34 of the vaporizer 30. To avoid icing occurring within the duct 98 itself, a minimum quantity of steam is circulated through the duct 98 at all times during operation of the vaporizer 30, with a pulse of steam (greater than the minimum quantity) circulated intermittently when de-icing is required. Alternatively, steam can be used to drive a steam turbine causing the turbine to spin providing rotation to a mechanical shaft to produce electricity used to power the heat cabling used in the embodiment illustrated in FIG. 6a. A dry inert gas stream can also be used to purge the duct 98 after each de-icing cycle.

An alternative embodiment of the onboard regasification facility 14 is illustrated in FIG. 7 for which like reference numerals refer to like parts, in which an intermediate fluid is directed to flow through the tubes 34 of an ambient air heat exchanger 40, the intermediate fluid being heated by heat exchange with ambient air acting on the exterior heat transfer surfaces of the ambient air heat exchanger 40. The heated intermediate fluid is then circulated to the vaporizer 30 in which the LNG is regasified to natural gas through heat exchange with the heated intermediate fluid. In this embodiment, the cooled intermediate fluid which exits the vaporizer 30 is directed to a surge tank 101 and then pumped back to the ambient air heat exchanger 40 using intermediate fluid pump 102. In this embodiment, icing can occur on the exterior heat transfer surfaces of the ambient air heat exchanger 40 when the temperature at the exterior heat transfer surface is below the freezing temperature of the water present in the ambient air.

Suitable intermediate fluids for use in the process and apparatus of the present invention include: glycol (such as ethylene glycol, diethylene glycol, triethylene glycol, or a mixture thereof); glycol-water mixtures; methanol; propanol; propane; butane, ammonia; formate; tempered water or fresh water; or any other fluid with an acceptable heat capacity, freezing, and boiling, points that is commonly known to a person skilled in the art. It is desirable to use an environmentally more acceptable material than glycol for the intermediate fluid. In this regard, it is preferable to use an intermediate fluid which comprises a solution containing an alkali metal formate, such as potassium formate or sodium formate in water or an aqueous solution of ammonium formate. Alternatively or additionally, an alkali metal acetate such as potassium acetate, or ammonium acetate may be used. The solutions may include amounts of alkali metal halides calculated to improve the freeze resistance of the combination, that is, to lower the freeze point beyond the level of a solution of potassium formate alone. The advantage of using an intermediate fluid with a low freezing point is that the cold intermediate fluid which exits the shell-side outlet 40 of the vaporizer 30 can be allowed to drop to a temperature in the range of −20° C. to −70° C., depending on the freezing point of the particular type of intermediate fluid selected. When this is allowed to occur, a layer of ice may form on a portion of the heat transfer surface of the ambient air heat exchanger which can be subjected to intermittent de-icing using a source of heat applied at the interface between the layer of ice and the heat transfer surface.

Heat transfer between the ambient air and the intermediate fluid can be assisted through the use of forced draft fans 44 arranged to direct the flow of air towards the heat exchangers 40 as described above.

Whilst only one vaporizer is illustrated in FIG. 2 and only one ambient air heat exchanger is illustrated in FIG. 7, it is to be understood that the regasification facility 10 can equally comprise a larger number of vaporizers 30 or heat exchangers 40 to suit the capacity of natural gas to be delivered from the regasification facility 10. By way of example, to provide sufficient surface area for heat exchange, the vaporizer 30 may be one of a plurality of vaporizers arranged in a variety of configurations, for example in series, in parallel, or in banks. The ambient air vaporizer 30 can be a finned tube heater, a bent-tube fixed-tube-sheet exchanger, a spiral tube exchanger, a plate-type heater, or any other heat exchanger commonly known by those skilled in the art that meets the temperature, volumetric, and heat absorption requirements for quantity of LNG to be regasified. It is preferable that the ambient air vaporizer is of a type which is best adapted to withstand the additional gravitational bending loads generated when the layer of ice is allowed to form on the external surfaces of the vaporizers and, in this regard, vertical tube bundles are preferred to horizontal tube bundles. The use of vertical tube passes is also better suited to reducing the overall footprint of the regasification facility 10. The vaporizers 30, heat exchangers, and fans 44 are designed to withstand the structural loads associated with being disposed on the deck of the RLNGC 12 during transit of the vessel at sea including the loads associated with motions and possibly green water loads as well as the loads experienced whilst the RLNGC is moored offshore during regasification.

The process and apparatus of the present invention provides a number of advantages over the prior art including the following:

a) the need to provide redundant vaporizers is overcome as icing can be managed without disrupting the flow of LNG through the regasification facility, reducing the overall footprint of the regasification and avoiding the extra expense of providing redundant vaporizers;

b) batch defrosting is achieved during continuous regasification;

c) the amount of heat required to displace the ice is far less than the amount of heat required to fully melt the ice, resulting in a reduction in energy used for de-icing operations; and

d) the source of heat for de-icing is provided in short, intermittent bursts which requires less energy than prior art methods which rely on ensuring that icing is avoided.

Now that several embodiments of the invention have been described in detail, it will be apparent to persons skilled in the relevant art that numerous variations and modifications can be made without departing from the basic inventive concepts. For example, microwaves can be used to generate a source of heat for de-icing if desired, while continuing to flow LNG through the tubes to achieve continuous LNG regasification. All such modifications and variations are considered to be within the scope of the present invention, the nature of which is to be determined from the foregoing description and the appended claims.

All of the patents cited in this specification, are herein incorporated by reference. It will be clearly understood that, although a number of prior art publications are referred to herein, this reference does not constitute an admission that any of these documents forms part of the common general knowledge in the art, in Australia or in any other country. In the summary of the invention, the description and claims which follow, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

I claim:

1. A process for regasifying a cryogenic liquid to gaseous form, the process comprising:
(a) transferring heat from ambient air to the cryogenic liquid across a heat transfer surface by circulating the cryogenic liquid or an intermediate fluid through an atmospheric vaporizer, wherein the ambient air and the cryogenic fluid or intermediate fluid are not in direct contact;
(b) allowing a layer of ice to form on at least that external portion of the heat transfer surface exposed to the atmosphere where the temperature at the heat transfer surface is below the freezing temperature of water; and
(c) intermittently dislodging the layer of ice from the vaporizer using a source of heat operatively associated with a control device, the control device arranged to generate a signal when de-icing is required, the source of heat being directed at the interface between the layer of ice and the heat transfer surface of the vaporizer, and whereby de-icing is achieved without the need to discontinue circulating the cryogenic fluid or the intermediate fluid through the vaporizer.

2. The process of claim 1, wherein the control device generates a signal to initiate (c) when the temperature of the gaseous form of the cryogenic liquid exiting the vaporizer drops below a predetermined minimum temperature.

3. The process of claim 1, wherein control device generates a signal to initiate (c) when the flow rate of the gaseous form of the cryogenic liquid exiting the vaporizer has dropped below a predetermined minimum flow rate.

4. The process of claim 1, wherein the source of heat for (c) is one or more of: electrical energy; waste heat recovered from a propulsion system of an RLNGC; steam from a waste heat boiler or other source; heat generated using a submerged combustion vaporizer; solar energy; electric heaters using the excess electric generating capacity of the propulsion plant when the RLNGC is moored; exhaust gas heat exchangers fitted to the combustion exhausts of a diesel engine or gas turbine; or natural gas-fired hot water or thermal oil heaters; or heat generated by direct firing using natural gas or oil.

5. The process of claim 1, wherein the source of heat for (c) is one or more electrical heating elements arranged at the interface between the heat transfer surface of the vaporizer and the layer of ice.

6. The process of claim 5 wherein the vaporizer includes at least one tube and the electrical heating elements are arranged on the exterior heat transfer surface of the tube.

7. The process of claim 5, wherein the vaporizer includes at least one tube, each tube including a plurality of radial fins, and wherein the electrical heating elements are arranged on one or all of the radial fins.

8. The process of claim 5, wherein the electrical heating elements are self-regulating.

9. The process of claim 1, wherein:
the vaporizer includes at least one tube; and
the source of heat for (c) is a heated fluid which is circulated, in response to the signal generated by the control device, through a de-icing duct arranged along at least that portion of the tube where icing occurs in use.

10. The process of claim 9, wherein:
the tube includes a plurality of radial fins; and
the de-icing duct is positioned at the base of adjacent radial fins.

11. The process of claim 9, wherein:
the tube includes a plurality of radial fins; and
each de-icing duct is arranged along the length of a radial fin so as to provide each fin with a hollow core through which the heated fluid is caused to flow.

12. The process of claim 9, wherein the heated fluid is dry superheated steam.

13. The process of claim 12, wherein the dry superheated steam is generated via a waste heat boiler arranged to exchange heat with hot exhaust gas generated by an engine.

14. The process of claim 1, wherein the intermediate fluid is selected from the group consisting of a glycol, a glycol-water mixture, methanol, propanol, propane, butane, ammonia, a formate, fresh water, and tempered water.

15. The process of claim 1, wherein (a) is encouraged through use of forced draft fans.

16. The process of claim 1, wherein the atmospheric vaporizer comprises a plurality of passes, the passes being spaced apart from one another and arranged in an array.

17. The process of claim 16, wherein each pass has a vertical orientation and adjacent passes are connected in series, in parallel, or in a combination of series and parallel configurations.

18. The process of claim 16, wherein each pass comprises at least one tube having a central bore through which the cryogenic liquid is caused to flow, each tube having a finned exterior surface, an inlet for fluid flow at one end, and an outlet for fluid flow at the other distal end of the tube.

19. The process of claim 1, wherein:
the vaporizer is provided in an regasification system for installation aboard a floating carrier vessel; and
the source of heat for (c) is recovered from the engines of the LNG carrier.

20. The process of claim 1 wherein the cryogenic fluid is LNG.

21. An apparatus for regasifying a cryogenic liquid to gaseous form, the apparatus comprising:
an atmospheric vaporizer for transferring heat from ambient air to the cryogenic liquid across a heat transfer surface by circulating the cryogenic liquid or an intermediate fluid through the atmospheric vaporizer, wherein the ambient air and the cryogenic fluid or intermediate fluid are not in direct contact;
a control device for intermittently dislodging a layer of ice from the vaporizer using a source of heat operatively associated with a control device, the layer of ice being allowed to form, in use, on at least that external portion of the heat transfer surface exposed to the atmosphere where the temperature at the heat transfer surface is below the freezing temperature of water, the control device being arranged to generate a signal when de-icing is required; and,
a source of heat directed at the interface between the layer of ice and the heat transfer surface of the vaporizer, whereby de-icing is achieved without the need to discontinue circulating the cryogenic fluid or the intermediate fluid through the vaporizer.

22. The apparatus of claim 21, wherein the control device includes:
a temperature sensor to measure the temperature of the gaseous form of the cryogenic liquid exiting the vaporizer; and
a signal generator for generating a signal to initiate intermittent de-icing when the temperature measured by the temperature sensor drops below a predetermined minimum temperature.

23. The apparatus of claim 21, wherein the control device further includes:
a flow meter to measure the flow rate of the gaseous form of the cryogenic liquid exiting the vaporizer; and
a signal generator for generating a signal to initiate intermittent de-icing when the flow rate measured by the flow meter drops below a predetermined minimum flow rate.

24. The apparatus of claim 21, wherein the source of heat is one or more of:
electrical energy; waste heat recovered from a propulsion system of an RLNGC; steam from a waste heat boiler or other source; heat generated using a submerged combustion vaporizer; solar energy; electric heaters using the excess electric generating capacity of the propulsion plant when the RLNGC is moored; exhaust gas heat exchangers fitted to the combustion exhausts of a diesel engine or gas turbine; or natural gas-fired hot water or thermal oil heaters; or heat generated by direct firing using natural gas or oil or microwave energy.

25. The apparatus of claim 21, wherein the source of heat is one or more electrical heating elements arranged at the interface between the heat transfer surface of the vaporizer and the layer of ice.

26. The apparatus of claim 25, wherein the vaporizer includes at least one tube and the electrical heating elements are arranged on the exterior heat transfer surface of the tube.

27. The apparatus of claim 25 wherein the vaporizer includes at leats one tube, each tube including a plurality of radial fins, and wherein the electrical heating elements are arranged on one or all of the radial fins.

28. The apparatus of claim 25, wherein the electrical heating elements are self-regulating.

29. The apparatus of claim 21, wherein:
the vaporizer includes at least one tube; and
the source of heat is a heated fluid which is circulated, in response to the signal generated by the control device, through a de-icing duct arranged along at least that portion of the tube where icing is expected to occur.

30. The apparatus of claim 29, wherein:
the tube includes a plurality of fins; and
the de-icing duct is positioned on the exterior heat transfer surfaces of the tube adjacent to the base of adjacent radial fins.

31. The apparatus of claim 29 wherein the tube includes a plurality of radial fins, and each de-icing duct is arranged along the length of a radial fin so as to provide each fin with a hollow core through which the heated fluid is caused to flow.

32. The apparatus of claim 29, wherein the heated fluid is dry superheated steam.

33. The apparatus of claim 32, wherein the dry superheated steam is generated using a waste heat boiler arranged to exchange heat with hot exhaust gas generated by an engine.

34. The apparatus of claim 21 further comprising forced draft fans for directing the flow of ambient air towards the vaporizer.

35. The apparatus of claim 21, wherein the vaporizer is provided in an regasification system for installation aboard a floating carrier vessel and the source of heat is recovered from the engines of the LNG carrier.
